(19) United States
(12) Patent Application Publication
(10) Pub. No.: US 2009/0152364 A1
(43) Pub. Date: Jun. 18, 2009

(54) RFID CARD WITH PIEZOELECTRIC ELEMENT

(75) Inventor: John William Spivey, JR., Matthews, NC (US)

Correspondence Address: TILLMAN WRIGHT, PLLC, PO BOX 473909, CHARLOTTE, NC, 28247, US

(73) Assignee: SPIVEY TECHNOLOGIES, LLC, Matthews, NC (US)

(21) Appl. No.: 12/334,442

(22) Filed: Dec. 12, 2008

Related U.S. Application Data
(63) Continuation-in-part of application No. 12/228,616, filed on Aug. 14, 2008.
(60) Provisional application No. 61/007,597, filed on Dec. 12, 2007.

(51) Int. Cl. G06K 19/067

(52) U.S. Cl. 235/492

(57) ABSTRACT

A radio-frequency identification (RFID) card includes an RFID element that is adapted to store RFID data information, an antenna, electrically connected at each of two ends to the RFID element, and a piezoelectric element, electrically connected to at least one of the two ends of the antenna, whereby mechanical actuation of the piezoelectric element enables the antenna to be energized by a transmission from an RFID reader terminal, thereby powering the transmission of RFID data information from the RFID element to the RFID reader terminal. An RFID system includes such a card, and an RFID reader terminal. A method of controlling the transmission of RFID data information from an RFID card includes positioning an RFID card, having a piezoelectric element electrically connected to an antenna that is electrically connected at each of two ends to an RFID element, in the vicinity of an RFID reader terminal; mechanically actuating the piezoelectric element; as a function of the mechanically actuating step, enabling the antenna to be energized by a transmission from an RFID reader terminal; and using the energy from the transmission from the RFID reader terminal, powering the transmission of RFID data information from the RFID element to the RFID reader terminal.

### CROSS-REFERENCE TO RELATED APPLICATION

The present application is a U.S. continuation-in-part patent application of, and claims priority under 35 U.S.C. §120 to, U.S. nonprovisional patent application Ser. No. 12/228,616, filed Aug. 14, 2008, which patent application is incorporated by reference herein. The present application is also a U.S. nonprovisional patent application of, and claims priority under 35 U.S.C. § 119(e) to, U.S. provisional patent application Ser. No. 61/007,597, filed Dec. 12, 2007, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

### Field of the Present Invention

The present invention relates generally to radio-frequency identification (“RFID”) access cards, and, in particular, to the use of a piezoelectric element to improve the security thereof.

### BACKGROUND

Cards having a magnetic strip thereon that stores data have been used for many years as credit cards, access cards and the like and are considered very secure. However, such cards may have a tendency to degrade over time due to the magnetic strip wearing out, the card creasing or bending and making the strip unreadable, or the like. Furthermore, such cards must be swiped through a reader in order to function.

More recently, RFID cards, which utilize an RFID element, often referred to as a “tag,” that may be read by radio wave by an RFID reader terminal, have been developed as a replacement for at least some types of cards, including some credit cards, transaction cards, passports and security access cards or badges. However, RFID cards tend to be less secure than magnetic strip cards, primarily because the information or data stored on the cards can be read anytime the card passed near a RFID reader terminal, making RFID technology highly insecure and prone to being easily hacked and the card information being stolen. In fact, the RFID information can be read at long distances without the card holder's knowledge, even when the user has the card secured in a wallet or handbag. Methods have been taken by manufacturers to issue shielding sleeves for RFID credit cards, transaction cards and security access cards as a safe guard to block the RF signal. However, as a practical matter, users often lose the sleeve or find it inconvenient to return the card to the shielding sleeve.

RFID elements are generally classified as “passive,” “active” or “semi-passive” in nature, depending upon whether they include a battery therein for powering operations, including communications between the RFID card and the RFID reader terminal (or in the case of semi-passive RFID elements, for powering the RFID element itself but not for powering communications). Recently, the use of piezoelectric materials has been proposed as an alternate or additional power source for such communications. Unfortunately, although useful for supplying an electric potential for a limited period of time, the use of piezoelectric elements for powering operation of the RFID element is not desirable because such an application requires substantial additional circuitry to store and/or dispense the electrical charge provided by the piezoelectric elements and to monitor the available charge as it is depleted to avoid “browning out” (electrically damaging) the primary RFID element, and such additional circuitry can be difficult to package and increases cost.

A piezoelectric material has been proposed for use as a mechanical switch whose actuation is triggered by an electric signal, but as with other mechanical switches, difficulties arise in manufacturing and use wherein the switch is unreliable. Generating an electric signal that may be used to connect together an antenna and RFID element incorporated within an RFID card, or that may be used to enable the RFID element.

No use of piezoelectric elements as an actuator in a simple, reliable circuit for an RFID card is known to exist.

Thus, a need exists for a card technology having the convenience of an RFID card but utilizing a simple reliable circuit, having a piezoelectric element actuator, for significantly greater security.

### SUMMARY OF THE PRESENT INVENTION

The present invention includes many aspects and features. Moreover, while many aspects and features relate to, and are described in, the context of RFID cards and RFID card systems, the present invention is not limited to use only in these contexts, as will become apparent from the following summaries and detailed descriptions of aspects, features, and one or more embodiments of the present invention.

Accordingly, one aspect of the present invention relates to a radio-frequency identification (RFID) card. The RFID card includes at least one card layer; and an electrical circuit, carried by the at least one card layer. The electrical circuit includes an RFID element that is adapted to store RFID data information, an antenna, electrically connected at each of two ends to the RFID element, and a piezoelectric element, electrically connected to at least one of the two ends of the antenna, whereby mechanical actuation of the piezoelectric element enables the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of a short-circuit from the antenna.

In a feature of this aspect of the invention, the short-circuit is removed from leads of the antenna.

In a feature of this aspect of the invention, the short-circuit is removed from antenna inputs on the RFID element.

In a feature of this aspect of the invention, the RFID element is implemented in an integrated circuit.

In a feature of this aspect of the invention, the RFID element does not include an integrated circuit.

In a feature of this aspect of the invention, the RFID card further includes an additional circuit portion, electrically connected to the antenna and to the piezoelectric element, that enables the antenna to be energized by the transmission from the RFID reader terminal.

In a feature of this aspect of the invention, the additional circuit portion includes a transistor that removes a short-circuit from the antenna when an electric potential, generated by the actuation of the piezoelectric element, is applied thereto.

In a feature of this aspect of the invention, the additional circuit portion further includes a diode, electrically connected between the piezoelectric element and the transistor, that rectifies the electric potential generated by the piezoelectric element.

In a feature of this aspect of the invention, the transistor is a junction gate field-effect transistor (JFET).

In a feature of this aspect of the invention, the transistor is a metal-oxide-semiconductor field-effect transistor (MOSFET).

In a feature of this aspect of the invention, a source lead of the transistor is electrically connected to a first end of the antenna and a drain lead of the transistor is electrically connected to a second end of the antenna.

In a feature of this aspect of the invention, the electric potential generated by the actuation of the piezoelectric element is applied to a gate lead of the transistor.

In a feature of this aspect of the invention, the additional circuit portion further includes a resistor, electrically connected to the transistor, to bleed stored capacitance from the transistor.

In a feature of this aspect of the invention, the additional circuit portion includes a capacitor network that tunes the circuit to the carrier frequency of the antenna when an electric potential, generated by the actuation of the piezoelectric element, is applied thereto.

In a feature of this aspect of the invention, the capacitor network includes a first capacitor and a second capacitor.

In a feature of this aspect of the invention, the RFID element includes two antenna inputs, and wherein the first capacitor is electrically connected across the two antenna inputs.

In a feature of this aspect of the invention, a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

In a feature of this aspect of the invention, the capacitor network is connected across the leads of the antenna.

In a feature of this aspect of the invention, the additional circuit portion is implemented together with the RFID element in a single integrated circuit.

In a feature of this aspect of the invention, the RFID element is implemented in an integrated circuit, and wherein the additional circuit portion is implemented separately from the integrated circuit of the RFID element.

In a feature of this aspect of the invention, the additional circuit portion is implemented in an integrated circuit that is separate from the integrated circuit of the RFID element.

Another aspect of the invention relates to a radio-frequency identification (RFID) card. The RFID card includes at least one card layer; and an electrical circuit, carried by the at least one card layer. The electrical circuit includes an RFID element that is adapted to store RFID data information, an antenna, having leads, electrically connected to the RFID element, an additional circuit portion arranged to controllably place a short-circuit across the leads of the antenna, and a piezoelectric element, electrically connected to the additional circuit portion, whereby mechanical actuation of the piezoelectric element removes the short-circuit from the leads of the antenna to enable the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of the short-circuit from the leads of the antenna.

In a feature of this aspect of the invention, the RFID element is implemented in an integrated circuit.

In a feature of this aspect of the invention, the RFID element does not include an integrated circuit.

In a feature of this aspect of the invention, the additional circuit portion is electrically connected to the antenna and to the piezoelectric element, and enables the antenna to be energized by the transmission from the RFID reader terminal.

In a feature of this aspect of the invention, the additional circuit portion includes a transistor that removes a short-circuit from the antenna when an electric potential, generated by the actuation of the piezoelectric element, is applied thereto.

In a feature of this aspect of the invention, the additional circuit portion further includes a diode, electrically connected between the piezoelectric element and the transistor, that rectifies the electric potential generated by the piezoelectric element.

In a feature of this aspect of the invention, the transistor is a junction gate field-effect transistor (JFET).

In a feature of this aspect of the invention, the transistor is a metal-oxide-semiconductor field-effect transistor (MOSFET).

In a feature of this aspect of the invention, a source lead of the transistor is electrically connected to a first end of the antenna and a drain lead of the transistor is electrically connected to a second end of the antenna.

In a feature of this aspect of the invention, the electric potential generated by the actuation of the piezoelectric element is applied to a gate lead of the transistor.

In a feature of this aspect of the invention, the additional circuit portion further includes a resistor, electrically connected to the transistor, to bleed stored capacitance from the transistor.

In a feature of this aspect of the invention, the additional circuit portion is implemented together with the RFID element in a single integrated circuit.

In a feature of this aspect of the invention, the RFID element is implemented in an integrated circuit, and wherein the additional circuit portion is implemented separately from the integrated circuit of the RFID element.

In a feature of this aspect of the invention, the additional circuit portion is implemented in an integrated circuit that is separate from the integrated circuit of the RFID element.

Another aspect of the invention relates to a radio-frequency identification (RFID) card. The RFID card includes at least one card layer and an electrical circuit, carried by the at least one card layer. The electrical circuit includes an RFID element that is adapted to store RFID data information, an antenna, having leads, electrically connected to the RFID element, a capacitor network arranged to controllably tune the antenna into and out of resonance with a carrier frequency, and a piezoelectric element, electrically connected to the capacitor network, whereby mechanical actuation of the piezoelectric element controllably tunes the antenna into resonance with the carrier frequency to enable the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of a short-circuit from the antenna.

In a feature of this aspect of the invention, the short-circuit is removed from the leads of the antenna.

In a feature of this aspect of the invention, the short-circuit is removed from antenna inputs on the RFID element.

In a feature of this aspect of the invention, the RFID element is implemented in an integrated circuit.

In a feature of this aspect of the invention, the RFID element does not include an integrated circuit.

In a feature of this aspect of the invention, the RFID card further includes an additional circuit portion, electrically connected to the antenna and to the piezoelectric element, that enables the antenna to be energized by the transmission from the RFID reader terminal.

In a feature of this aspect of the invention, the additional circuit portion is implemented together with the RFID element in a single integrated circuit.

In a feature of this aspect of the invention, the RFID element is implemented in an integrated circuit, and wherein the additional circuit portion is implemented separately from the integrated circuit of the RFID element.

In a feature of this aspect of the invention, the additional circuit portion is implemented in an integrated circuit that is separate from the integrated circuit of the RFID element.

In a feature of this aspect of the invention, the capacitor network includes a first capacitor and a second capacitor.

In a feature of this aspect of the invention, the RFID element includes two antenna inputs, and wherein the first capacitor is electrically connected across the two antenna inputs.

In a feature of this aspect of the invention, a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

In a feature of this aspect of the invention, the capacitor network is connected across the leads of the antenna.

Another aspect of the invention relates to a radio-frequency identification (RFID) card access system. The RFID card access system includes an RFID reader terminal and an RFID card. The RFID card includes an RFID element that is adapted to store RFID data information, an antenna, electrically connected at each of two ends to the RFID element, and a piezoelectric element, electrically connected to at least one of the two ends of the antenna, whereby mechanical actuation of the piezoelectric element enables the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of a short-circuit from the antenna.

In a feature of this aspect of the invention, the short-circuit is removed from leads of the antenna.

In a feature of this aspect of the invention, the short-circuit is removed from antenna inputs on the RFID element.

In a feature of this aspect of the invention, the RFID element is implemented in an integrated circuit.

In a feature of this aspect of the invention, the RFID element does not include an integrated circuit.

In a feature of this aspect of the invention, the RFID card further includes a circuit portion, electrically connected to the antenna and to the piezoelectric element, that enables the antenna to be energized by the transmission from the RFID reader terminal.

In a feature of this aspect of the invention, the circuit portion includes a transistor that removes a short-circuit from the antenna when an electric potential, generated by the actuation of the piezoelectric element, is applied thereto.

In a feature of this aspect of the invention, the circuit portion further includes a diode, electrically connected between the piezoelectric element and the transistor, that rectifies the electric potential generated by the piezoelectric element.

In a feature of this aspect of the invention, the transistor is a junction gate field-effect transistor (JFET).

In a feature of this aspect of the invention, the transistor is a metal-oxide-semiconductor field-effect transistor (MOSFET).

In a feature of this aspect of the invention, a source lead of the transistor is electrically connected to a first end of the antenna and a drain lead of the transistor is electrically connected to a second end of the antenna.

In a feature of this aspect of the invention, the electric potential generated by the actuation of the piezoelectric element is applied to a gate lead of the transistor.

In a feature of this aspect of the invention, the circuit portion further includes a resistor, electrically connected to the transistor, to bleed stored capacitance from the transistor.

In a feature of this aspect of the invention, the circuit portion includes a capacitor network that tunes the circuit to the carrier frequency of the antenna when an electric potential, generated by the actuation of the piezoelectric element, is applied thereto.

In a feature of this aspect of the invention, the capacitor network includes a first capacitor and a second capacitor.

In a feature of this aspect of the invention, the RFID element includes two antenna inputs, and wherein the first capacitor is electrically connected across the two antenna inputs.

In a feature of this aspect of the invention, a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

In a feature of this aspect of the invention, the capacitor network is connected across the leads of the antenna.

In a feature of this aspect of the invention, the circuit portion is implemented together with the RFID element in a single integrated circuit.

In a feature of this aspect of the invention, the RFID element is implemented in an integrated circuit, and wherein the circuit portion is implemented separately from the integrated circuit of the RFID element.

In a feature of this aspect of the invention, the circuit portion is implemented in an integrated circuit that is separate from the integrated circuit of the RFID element.

In a feature of this aspect of the invention, the RFID card is a security access card.

In a feature of this aspect of the invention, the RFID card is a security badge.

In a feature of this aspect of the invention, the RFID card is a credit card.

In a feature of this aspect of the invention, the RFID card is a transaction card

In a feature of this aspect of the invention, the RFID card is a passport.

In a feature of this aspect of the invention, the RFID card is a first RFID card, the RFID card access system further including a second RFID card that contains no piezoelectric element, wherein the RFID reader terminal is operable with both the first RFID card and the second RFID card.

Another aspect of the invention relates to a radio-frequency identification (RFID) card access system. The RFID card access system includes an RFID reader terminal and an RFID card. The RFID card includes an RFID element that is adapted to store RFID data information, an antenna, having leads, electrically connected to the RFID element, a circuit portion arranged to controllably place a short-circuit across the leads of the antenna, and a piezoelectric element, electrically connected to the additional circuit portion, whereby mechanical actuation of the piezoelectric element removes the short-circuit from the leads of the antenna to enable the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of the short-circuit from the leads of the antenna.

In a feature of this aspect of the invention, the RFID element is implemented in an integrated circuit.

In a feature of this aspect of the invention, the RFID element does not include an integrated circuit.

In a feature of this aspect of the invention, the circuit portion is electrically connected to the antenna and to the piezoelectric element, and enables the antenna to be energized by the transmission from the RFID reader terminal.

In a feature of this aspect of the invention, the circuit portion includes a transistor that removes a short-circuit from the antenna when an electric potential, generated by the actuation of the piezoelectric element, is applied thereto.

In a feature of this aspect of the invention, the circuit portion further includes a diode, electrically connected between the piezoelectric element and the transistor, that rectifies the electric potential generated by the piezoelectric element.

In a feature of this aspect of the invention, the transistor is a junction gate field-effect transistor (JFET).

In a feature of this aspect of the invention, the transistor is a metal-oxide-semiconductor field-effect transistor (MOSFET).

In a feature of this aspect of the invention, a source lead of the transistor is electrically connected to a first end of the antenna and a drain lead of the transistor is electrically connected to a second end of the antenna.

In a feature of this aspect of the invention, the electric potential generated by the actuation of the piezoelectric element is applied to a gate lead of the transistor.

In a feature of this aspect of the invention, the circuit portion further includes a resistor, electrically connected to the transistor, to bleed stored capacitance from the transistor.

In a feature of this aspect of the invention, the circuit portion is implemented together with the RFID element in a single integrated circuit.

In a feature of this aspect of the invention, the RFID element is implemented in an integrated circuit, and wherein the circuit portion is implemented separately from the integrated circuit of the RFID element.

In a feature of this aspect of the invention, the circuit portion is implemented in an integrated circuit that is separate from the integrated circuit of the RFID element.

In a feature of this aspect of the invention, the RFID card is a security access card.

In a feature of this aspect of the invention, the RFID card is a security badge.

In a feature of this aspect of the invention, the RFID card is a credit card.

In a feature of this aspect of the invention, the RFID card is a transaction card

In a feature of this aspect of the invention, the RFID card is a passport.

In a feature of this aspect of the invention, the RFID card is a first RFID card, the RFID card access system further including a second RFID card that contains no piezoelectric element, wherein the RFID reader terminal is operable with both the first RFID card and the second RFID card.

Another aspect of the invention relates to a radio-frequency identification (RFID) card access system. The RFID card access system includes an RFID reader terminal and an RFID card. The RFID card includes an RFID element that is adapted to store RFID data information, an antenna, having leads, electrically connected to the RFID element, a capacitor network arranged to controllably tune the antenna into and out of resonance with a carrier frequency, and a piezoelectric element, electrically connected to the capacitor network, whereby mechanical actuation of the piezoelectric element controllably tunes the antenna into resonance with the carrier frequency to enable the antenna to be energized by a transmission from an RFID reader terminal, thereby powering the transmission of RFID data information from the RFID element to the RFID reader terminal.

In a feature of this aspect of the invention, mechanical actuation of the piezoelectric element occurs when the at least one card layer is flexed.

In a feature of this aspect of the invention, mechanical actuation of the piezoelectric element causes the removal of a short-circuit from the antenna.

In a feature of this aspect of the invention, the short-circuit is removed from the leads of the antenna.

In a feature of this aspect of the invention, the short-circuit is removed from antenna inputs on the RFID element.

In a feature of this aspect of the invention, the RFID element is implemented in an integrated circuit.

In a feature of this aspect of the invention, the RFID element does not include an integrated circuit.

In a feature of this aspect of the invention, the RFID card further includes an additional circuit portion, electrically connected to the antenna and to the piezoelectric element, that enables the antenna to be energized by the transmission from the RFID reader terminal.

In a feature of this aspect of the invention, the additional circuit portion is implemented together with the RFID element in a single integrated circuit.

In a feature of this aspect of the invention, the RFID element is implemented in an integrated circuit, and wherein the additional circuit portion is implemented separately from the integrated circuit of the RFID element.

In a feature of this aspect of the invention, the additional circuit portion is implemented in an integrated circuit that is separate from the integrated circuit of the RFID element.

In a feature of this aspect of the invention, the capacitor network includes a first capacitor and a second capacitor.

In a feature of this aspect of the invention, the RFID element includes two antenna inputs, and wherein the first capacitor is electrically connected across the two antenna inputs.

In a feature of this aspect of the invention, a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

In a feature of this aspect of the invention, the capacitor network is connected across the leads of the antenna.

In a feature of this aspect of the invention, the RFID card is a security access card.

In a feature of this aspect of the invention, the RFID card is a security badge.

In a feature of this aspect of the invention, the RFID card is a credit card.

In a feature of this aspect of the invention, the RFID card is a transaction card

In a feature of this aspect of the invention, the RFID card is a passport.

In a feature of this aspect of the invention, the RFID card is a first RFID card, the RFID card access system further including a second RFID card that contains no piezoelectric element, wherein the RFID reader terminal is operable with both the first RFID card and the second RFID card.

Another aspect of the invention relates to a method of controlling the transmission of radio-frequency identification (RFID) data information from an RFID card. The method includes positioning an RFID card, having a piezoelectric element electrically connected to an antenna that is electrically connected at each of two ends to an RFID element, in the vicinity of an RFID reader terminal; mechanically actuating the piezoelectric element; as a function of the mechanically actuating step, enabling the antenna to be energized by a transmission from an RFID reader terminal; and using the energy from the transmission from the RFID reader terminal, powering the transmission of RFID data information from the RFID element to the RFID reader terminal.

In a feature of this aspect of the invention, mechanically actuating the piezoelectric element includes flexing the RFID card.

In a feature of this aspect of the invention, enabling the antenna to be energized by a transmission from an RFID reader terminal includes causing the removal of a short-circuit from the antenna.

In a feature of this aspect of the invention, causing the removal of a short-circuit from the antenna includes causing the removal of the short-circuit from leads of the antenna.

In a feature of this aspect of the invention, causing the removal of a short-circuit from the antenna includes causing the removal of the short-circuit from antenna inputs on the RFID element.

In a feature of this aspect of the invention, the RFID element is implemented in an integrated circuit.

In a feature of this aspect of the invention, the RFID element does not include an integrated circuit.

In a feature of this aspect of the invention, enabling the antenna to be energized by a transmission from an RFID reader terminal is carried out by a circuit portion, in the RFID card, that is electrically connected to the antenna and to the piezoelectric element.

In a feature of this aspect of the invention, the method further includes the step of removing, by a transistor in the circuit portion, a short-circuit from the antenna when an electric potential, generated by the actuation of the piezoelectric element, is applied thereto.

In a feature of this aspect of the invention, the method further includes the step of rectifying, via a diode in the circuit portion, the electric potential generated by the piezoelectric element.

In a feature of this aspect of the invention, the transistor is a junction gate field-effect transistor (JFET).

In a feature of this aspect of the invention, the transistor is a metal-oxide-semiconductor field-effect transistor (MOSFET).

In a feature of this aspect of the invention, a source lead of the transistor is electrically connected to a first end of the antenna and a drain lead of the transistor is electrically connected to a second end of the antenna.

In a feature of this aspect of the invention, the method further includes the step of applying the electric potential generated by the actuation of the piezoelectric element to a gate lead of the transistor.

In a feature of this aspect of the invention, the method further includes the step of bleeding, via a resistor in the circuit portion, stored capacitance from the transistor.

In a feature of this aspect of the invention, the method further includes the step of tuning, via a capacitor network in the circuit portion, the circuit to the carrier frequency of the antenna when an electric potential, generated by the actuation of the piezoelectric element, is applied thereto.

In a feature of this aspect of the invention, the capacitor network includes a first capacitor and a second capacitor.

In a feature of this aspect of the invention, the RFID element includes two antenna inputs, and wherein the first capacitor is electrically connected across the two antenna inputs.

In a feature of this aspect of the invention, a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

In a feature of this aspect of the invention, the capacitor network is connected across the leads of the antenna.

In a feature of this aspect of the invention, the circuit portion is implemented together with the RFID element in a single integrated circuit.

In a feature of this aspect of the invention, the RFID element is implemented in an integrated circuit, and wherein the circuit portion is implemented separately from the integrated circuit of the RFID element.

In a feature of this aspect of the invention, the circuit portion is implemented in an integrated circuit that is separate from the integrated circuit of the RFID element.

Another aspect of the invention relates to a method of controlling the transmission of radio-frequency identification (RFID) data information from an RFID card. The method includes positioning an RFID card, having a piezoelectric element electrically connected to a circuit portion that normally places a short-circuit across the leads of an antenna that is electrically connected to an RFID element, in the vicinity of an RFID reader terminal; mechanically actuating the piezoelectric element; as a function of the mechanically actuating step, temporarily removing the short-circuit from the leads of the antenna, thereby enabling the antenna to be energized by a transmission from an RFID reader terminal; and using the energy from the transmission from the RFID reader terminal, powering the transmission of RFID data information from the RFID element to the RFID reader terminal.

Another aspect of the invention relates to a method of controlling the transmission of radio-frequency identification (RFID) data information from an RFID card. The method includes providing an RFID card having a piezoelectric element electrically connected to a capacitor network that normally detunes an antenna out of resonance from a carrier frequency, the antenna being electrically connected to an RFID element; positioning the RFID card in the vicinity of an RFID reader terminal; mechanically actuating the piezoelectric element; as a result of the mechanically actuating step, enabling the antenna to be energized by a transmission from an RFID reader terminal; and using the energy from the transmission from the RFID reader terminal, powering the transmission of RFID data information from the RFID element to the RFID reader terminal.

Another aspect of the invention relates to a radio-frequency identification (RFID) card. The RFID card includes at least one card layer and an electrical circuit, carried by the at least one card layer. The electrical circuit includes an RFID element that is adapted to store RFID data information, an antenna, having two ends, that is electrically connected to the RFID element, a transistor having outputs electrically connected to the ends of the antenna, and a piezoelectric element adapted to controllably supply an electric potential to the transistor; wherein when the at least one card layer is not flexed, the outputs of the transistor apply a short circuit between the antenna ends; and wherein when the at least one card layer is flexed, the piezoelectric element is actuated, causing the electric potential to be supplied to the transistor such that the short circuit is removed from the antenna ends.

In addition to the aforementioned aspects and features of the present invention, it should be noted that the present invention further encompasses the various possible combinations and subcombinations of such aspects and features.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a schematic view of an RFID card access system in accordance with one or more preferred embodiments of the present invention;

FIG. 2 is a schematic diagram of a prior art electrical circuit for use in an RFID card access system;

FIG. 3 is a perspective view of the RFID card of FIG. 1;

FIG. 4 is a perspective view of the layers of one implementation of the RFID card of FIG. 3;

FIG. 5 is a top view of the middle layer of the RFID card of FIG. 4;

FIG. 6 is a perspective view of the layers of another implementation of the RFID card of FIG. 3;

FIG. 7 is a schematic diagram of one implementation of the electrical circuit of FIGS. 4-6;

FIG. 8 is a schematic diagram of another implementation of the electrical circuit of FIGS. 4-6;

FIG. 9 is a schematic diagram of another implementation of the electrical circuit of FIGS. 4-6;

FIG. 10 is a perspective view of the RFID card of FIG. 1, shown in an activated state;

FIG. 11 is a perspective view of the middle layer of the RFID card of FIG. 4, shown in an activated state; and

FIG. 12 is a perspective view of the RFID card of FIG. 1, shown in an alternative activated state.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

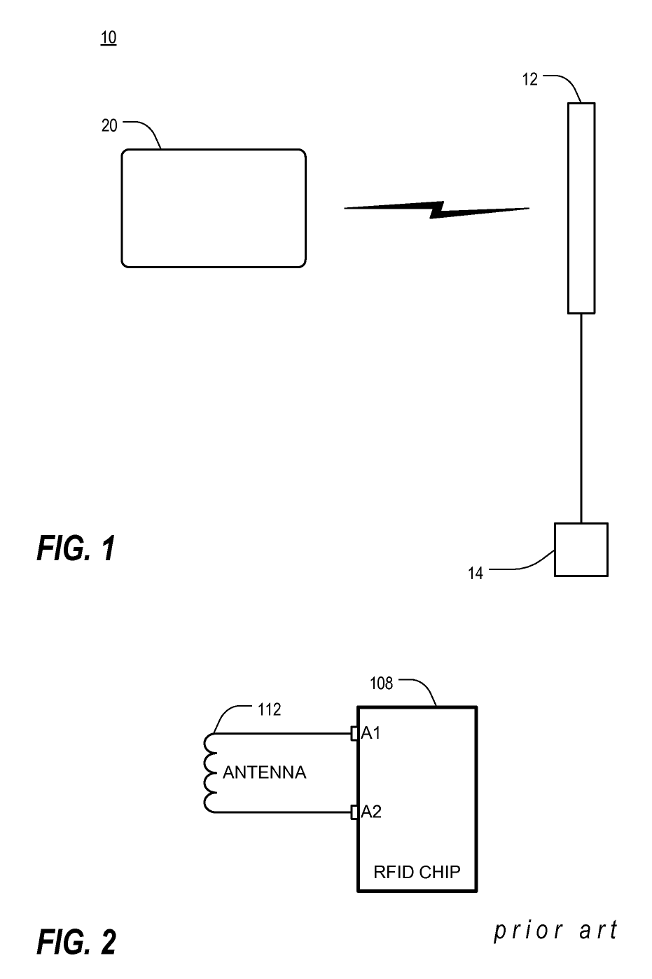

FIG. 1 is a schematic view of an RFID card access system 10 in accordance with one or more preferred embodiments of the present invention. As shown therein, the system 10 includes one or more RFID cards 20, an RFID reader terminal 12 and a control object 14, which may be a system, door lock, or any other object for or to which access may be obtained via the RFID reader terminal 12 using an authorized RFID card 20. Conventionally, the RFID cards used with an RFID card access system such as the system 10 of FIG. 1 utilize a simple antenna to energize an RFID element sufficiently to cause RFID data information to be transmitted thereby. FIG. 2 is a schematic diagram of a prior art electrical circuit for use in a conventional card in an RFID card access system. As shown therein, the RFID element 108, which contains the data information to be read by the RFID reader terminal 12, has an antenna 112 coupled thereto via antenna leads labeled “A1” and “A2.” When the antenna receives an appropriate signal from the RFID reader terminal 12, the antenna 112 effectively activates the RFID element 108, and the RFID element 108 can remain activated for as long as the antenna 112 continues to receive such signal.

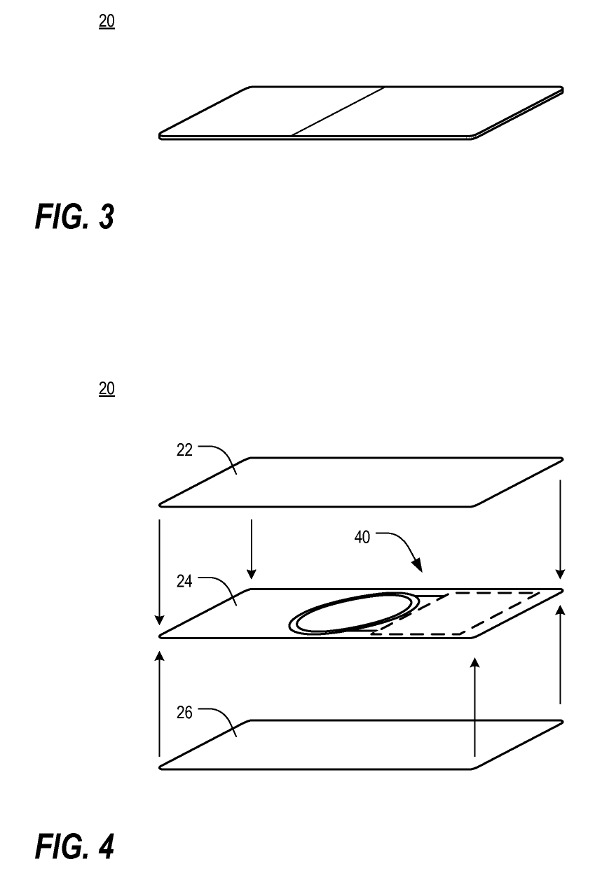

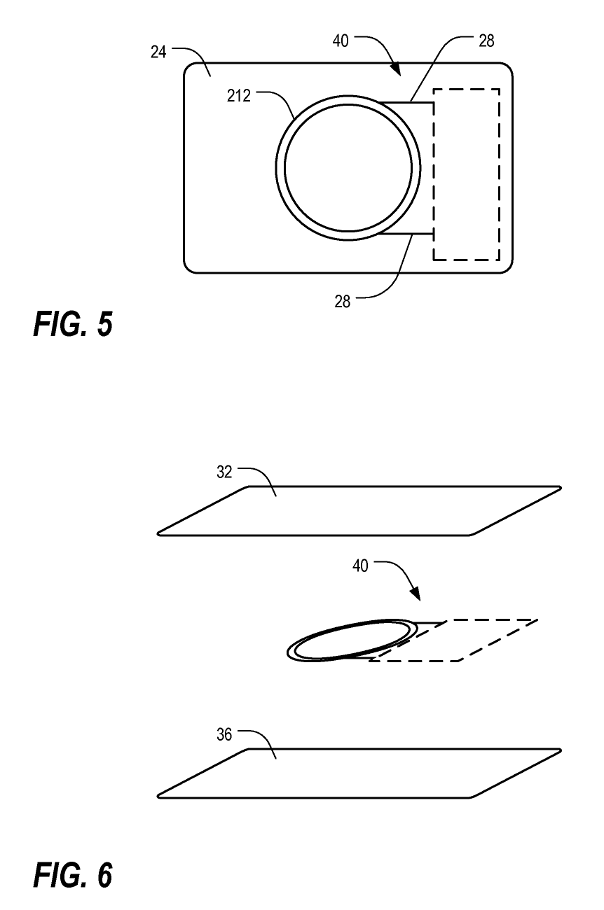

FIG. 3 is a perspective view of the RFID card 20 of FIG. 1. As generally illustrated thereby, the RFID card 20 of the present invention, like conventional RFID cards, may have a footprint similar to that of a conventional credit card and its thickness is preferably not much more than that of a conventional credit card. The RFID card 20 is preferably of laminar construction. FIG. 4 is a perspective view of the layers 22,24,26 of one implementation of the RFID card 20 of FIG. 3, and FIG. 5 is a top view of the middle layer 24 of the RFID card 20 of FIG. 4. As shown therein, the card 20 includes a circuit layer 24, including an electrical circuit 40, sandwiched between a top layer 22 and a bottom layer 26. The top and bottom layers 22,26 may be of conventional construction, typically including some formulation of PVC. The circuit layer 24 may be include the circuit elements placed or formed on a thin sheet of substrate, or may be detachable from such a substrate once placed on one of the other layers 22,26.

FIG. 6 is a perspective view of the layers 32,36 of another implementation of the RFID card 20 of FIG. 3. The illustrated implementation may reflect the previously-described arrangement wherein the elements of the circuit 40 have been detached from their substrate, or may reflect an arrangement where the circuit elements are applied directly to one of the other layers 32,36. One or both of the top and bottom layers 32,36 may be modified in order to accommodate such an arrangement.

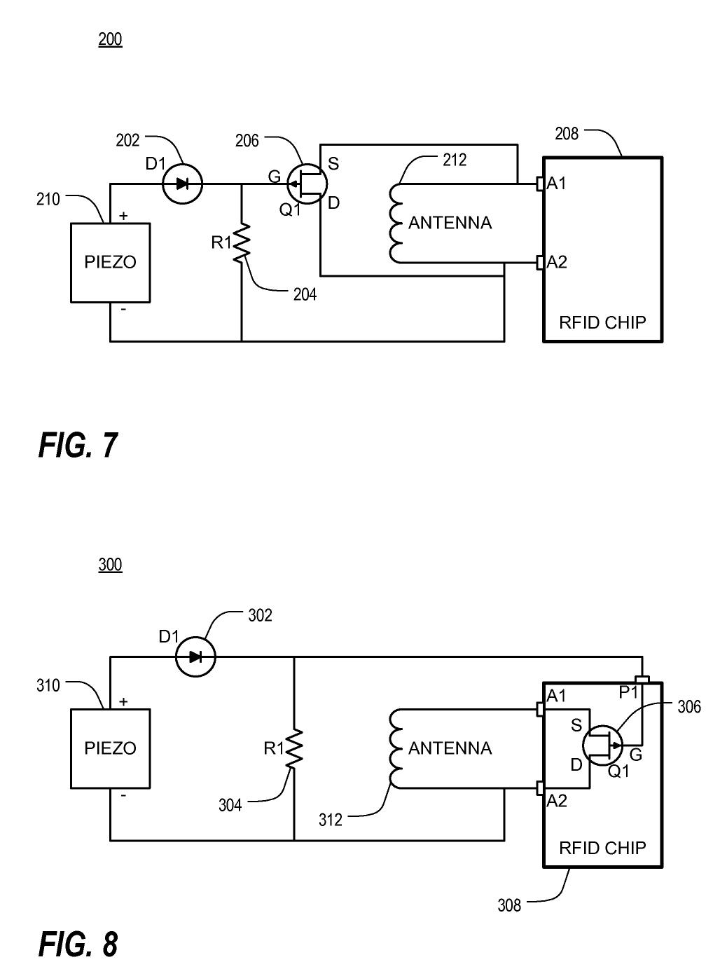

FIG. 7 is a schematic diagram of one implementation 200 of the electrical circuit 40 of FIGS. 4-6. As shown therein, the circuit 200 is a passive RFID tag circuit that includes an RFID element 208, a piezoelectric element 210, an antenna 212, a transistor 206, a resistor 204 and a diode 202. The RFID element 208, which is preferably an integrated circuit, contains the data information to be read by the RFID reader terminal 12. Although the RFID element 208 is preferably an integrated circuit (IC), it will be appreciated that future RFID element technologies may not utilize IC's, and that such technologies do not depart from the scope of the present invention. The RFID element 208 is coupled via leads labeled “A1” and “A2” to the antenna 212 which in passive RFID tag technologies must be energized by the RFID reader terminal 12 in order for the data information to be transmitted by the circuit 40.

In addition, however, the RFID element 208 is further coupled to the transistor 206, labeled “Q1.” The transistor 206 is shown as a junction gate field-effect transistor (“JFET”); however, it will be appreciated that a metal-oxide-semiconductor field-effect transistor (“MOSFET”) or other similar transistor component can be used, and that the transistor may utilize a channel of either P-type or N-type. The “S” source lead of the transistor 206 is connected to the A1 lead of the antenna 212, and the “D” drain lead of the transistor 206 is connected to the A2 lead of the antenna 212. When de-energized, the transistor 206 creates a short circuit across the A1 and A2 leads of the antenna 212, which in turn prevents the antenna from being energized by the RFID reader terminal 12.

The transistor 206 is effectively controlled by the piezoelectric element 210, which is coupled to the “G” gate lead of the transistor 206 via the diode 202 and the resistor 204. The resistor 204, labeled “R1,” is electrically connected to the G lead of the transistor 206 and is used to bleed any stored capacitance off the JFET. The diode 202, labeled “D1,” is used to rectify the voltage generated by the piezoelectric element 210; however, the diode 202 is not required and the circuit will operate without it. The positive output side of the piezoelectric element 210 is electrically connected to the anode of the diode 202 and the negative output side of the piezoelectric element 210 is electrically connected to the resistor 204 on the side opposite that of the diode 202. The negative output side of the piezoelectric element 210 is also electrically connected to the D lead of the transistor 206 and the A2 lead of the antenna 212.

As is well known, piezoelectric materials (as well as certain other materials, such as electroactive polymers, the use of which is likewise contemplated in one or more embodiments of the present inventions) generate an electric potential in response to applied mechanical stress. Assuming the material is not short-circuited, the applied charge induces a voltage across the material. Thus, when the piezoelectric element 210 is bent or deflected slightly, the mechanical stress causes an electrical potential (voltage) to be generated with a waveform that is generally sinusoidal in nature, including both positive and negative portions. If the potential is of a sufficient amount, then the diode 202, which is used to regulate the piezoelectric element 210 output voltage, becomes conductive and a current enters the G lead of the transistor 206. This, in turn, energizes the transistor 206, which in effect switches the transistor 206 “off” (i.e., an “open circuit” is produced between the source and the drain of the transistor 206 in that current flow is no longer conducted therebetween). During the open circuit condition, the leads of the antenna are no longer short-circuited together, thereby permitting the antenna 212 to operate normally, i.e., the antenna 212 is capable of being energized by an appropriate signal from the RFID reader terminal 12. Furthermore, in this state, the information (data) stored in a memory of the RFID element 208 can be transmitted back to the RFID reader terminal 12 via the antenna 212. However, the open circuit condition between the source and drain will generally last at most only a few seconds, because the resistor 204 will bleed off the stored capacitance from the G lead of the transistor 206, and once the capacitance is bled off the transistor 206 will in effect be switched back “on” as a short circuit is once again placed across the antenna 212. Once in this state, data from the RFID element 208 can no longer be read by the RFID tag reader 12 unless the piezoelectric element 210 is again activated.

In some embodiments, the antenna 212 is provided in the form of a wire of a very thin gauge that is coiled into a flat ring or disk, such as is shown in FIGS. 4-6. Leads 28 (identified in FIG. 5) may be formed from the same material. Low frequency products, i.e., those in the 125 MHz range, may be more likely to make use of this antenna type because of the lengths required of such antennae. However, high frequency products, i.e., those in the 13.5 GHz range, may likewise utilize this type of antenna.

In other embodiments, the antenna 212 is provided in the form of a thin film material (not shown). For the thin film assembly method the antenna, leads, contacts, etc. are typically either “printed” directly on a thin substrate or applied using masking and material deposition techniques. The RFID element 208 is then physically attached to its contact patch or area.

The piezoelectric element 210 may be of a ceramic type or a thin film type. Selection of a particular material may be determined based on factors including cost, manufacturability, durability, and the like so long as the element 210 provides sufficient capacity to drive the circuit 40. In some embodiments, the piezoelectric element 210 may be a simple brass disk that contains a ceramic material. In some other embodiments, the piezoelectric element 210 may be a thin metallic film. In still other embodiments, the piezoelectric element 210 is a very thin ceramic fiber which may be manipulated in the same ways as electrical wire, i.e., it may be spun, wrapped, wound, woven, and the like.

The size, shape and location of the piezoelectric element may be dependent on how the card 20 is to be bent or flexed, where it is to be flexed, how much it is to be flexed, what read distance is acceptable, and the like. Of course, these parameters are dependent, in part, on the amount of available space in the card 20.

If desired, circuit size may be reduced by combining one or more elements of the circuit implementation 200 of FIG. 7 into a single integrated circuit. For example, FIG. 8 is a schematic diagram of another implementation 300 of the electrical circuit 40 of FIGS. 4-6. In this implementation 300 of the circuit 40, the transistor Q1 is combined with the RFID element in a single IC 308. Otherwise, this implementation 300 of the circuit 40 is similar to that of FIG. 7. The transistor 306, which may be for example a JFET has an S lead that is connected to the A1 lead of the antenna 312 and a D lead that is connected to the A2 lead of the antenna 312. The piezoelectric element 310 is coupled to the G lead of the transistor 306 (via an input to the RFID element 308 labeled “P1”) via the diode 302 and the resistor 304. As in the circuit implementation 200 of FIG. 7, the resistor 304 is used to bleed any stored capacitance off the transistor 306 and the diode 302 may be used to rectify the voltage generated by the piezoelectric element 310. Once again, when de-energized, the transistor 306 creates a short circuit across the A1 and A2 leads of the antenna 312, which in turn prevents the antenna 312 from being energized by the RFID reader terminal 12. However, when the piezoelectric element 310 is bent or deflected slightly, the mechanical stress causes an electrical potential (voltage) to be generated. If the potential is of a sufficient amount, then the diode 302 becomes conductive and a current enters the G lead of the transistor 306. This, in turn, energizes the transistor 306, which in effect switches the transistor 306 “off” (i.e., an “open circuit” is produced between the source and the drain of the transistor 306 in that current flow is no longer conducted therebetween). During the open circuit condition, the leads of the antenna 312 are no longer short-circuited together, thereby permitting the antenna 312 to operate normally, i.e., the antenna 312 is capable of being energized by an appropriate signal from the RFID reader terminal 12. In this state, the information (data) stored in a memory of the RFID element 308 can be transmitted back to the RFID reader terminal 12. When the resistor 304 bleeds off the stored capacitance from the G lead of the transistor 306, the transistor 306 will in effect be switched back “on” as a short circuit is once again placed across the antenna 312. Once in this state, data from the RFID element 308 can no longer be read by the RFID tag reader 12 unless the piezoelectric element 310 is again activated.

It will be appreciated that the elements of the circuit 40 may be arranged in other ways as well. For example, rather than utilizing separate circuit elements, all circuit elements (other than the piezoelectric element), could be included in a single integrated circuit. Alternatively, all circuit elements other than the piezoelectric element and the RFID element could be included in a single integrated circuit, in which case a conventionally-manufactured RFID element could be utilized. Selection of a particular approach may be based on manufacturability and other factors.

In both of the implementations 200,300 of FIGS. 7 and 8, when the transistor 206,306 is not energized by the respective piezoelectric element 210,310, the antenna 212,312 is “detuned” because a short-circuit is created across the antenna leads. When the energy from the piezoelectric element energizes the transistor, removing the short-circuit from across the antenna leads, the circuit is in resonance with the carrier frequency and the RFID element 208,308 is powered up such that RFID data information may be transmitted to the RFID reader terminal 12.

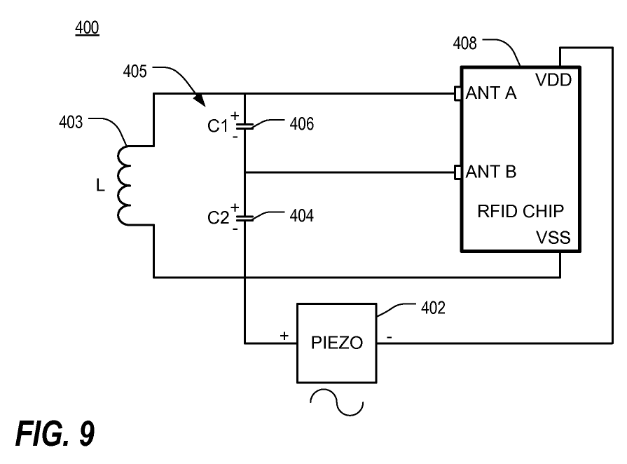

FIG. 9 is a schematic diagram of another implementation 400 of the electrical circuit 40 of FIGS. 4-6. As shown therein, the circuit implementation 400 is a passive RFID tag circuit that includes an RFID element 408, a piezoelectric element 402, an antenna 403 and a capacitor network 405. In the illustrated embodiment, the capacitor network 405 includes a pair of capacitors 404,406 that are connected variously to the RFID element 408, the antenna 403 and the piezoelectric element 402, but it will be appreciated that the number and arrangement of capacitors in the network may vary and that other conventional circuit elements, such as resistors, may likewise be included. The capacitor network 405 is utilized for circuit resonance, i.e., to tune the circuit to the carrier frequency of the antenna 403. More particularly, the circuit is tuned by charging the capacitors, but the capacitors 404,406 will not charge unless the proper electric potential is supplied to them by the piezoelectric element 402. In the absence of such potential, the capacitor network 405 forces the circuit out of resonance with regard to the carrier frequency, and the antenna cannot respond to a normal transmission from an RFID reader terminal 12.

The RFID element 408, which is preferably an integrated circuit, contains the data information to be read by the RFID reader terminal 12. The RFID element 408 is coupled via leads labeled “ANT A” and “ANT B” to the capacitors 404,406 and the antenna 403, which in passive RFID tag technologies must be energized by the RFID reader terminal 12 in order for the data information to be transmitted by the circuit 40. The positive output side of the piezoelectric element 402 is electrically connected to the negative side of one capacitor 404.

When the piezoelectric element 402 is bent or deflected slightly, the mechanical stress causes an electrical potential (voltage) to be generated with a waveform that is generally sinusoidal in nature, including both positive and negative portions. If the potential is of a sufficient amount, then the waveform when negative will allow the energy collected at the antenna 403 to pass to the RFID element 408 powering up the RFID element 408 and the information stored will pass through the antenna 403 and is wirelessly transferred to the RFID reader terminal 12.

In use, the RFID reader terminal 12 is operatively connected to the control object 14. Once installed and activated, the RFID reader terminal 12 emits low-power radio frequency signals whose electromagnetic component is received by the antenna 212,312,403. The electromagnetic component of these signals, though low in magnitude, is sufficient to power the necessary operation of the circuit 40. However, the antenna cannot operate until the respective piezoelectric element 210,310,402 is actuated. More particularly, if the respective piezoelectric element is bent or deflected while the antenna is energized by the transmission from the RFID reader terminal 12, then the transmission from the RFID reader terminal 12 activates the respective RFID element 208,308,408. The information (data) stored in the RFID element is then transmitted back to the RFID reader terminal 12 via the antenna (or piezoelectric element functioning as an antenna). Such transmission back to the RFID reader terminal 12 must occur while the antenna is still active, and thus must occur before the energy pulse produced by the piezoelectric element expires.

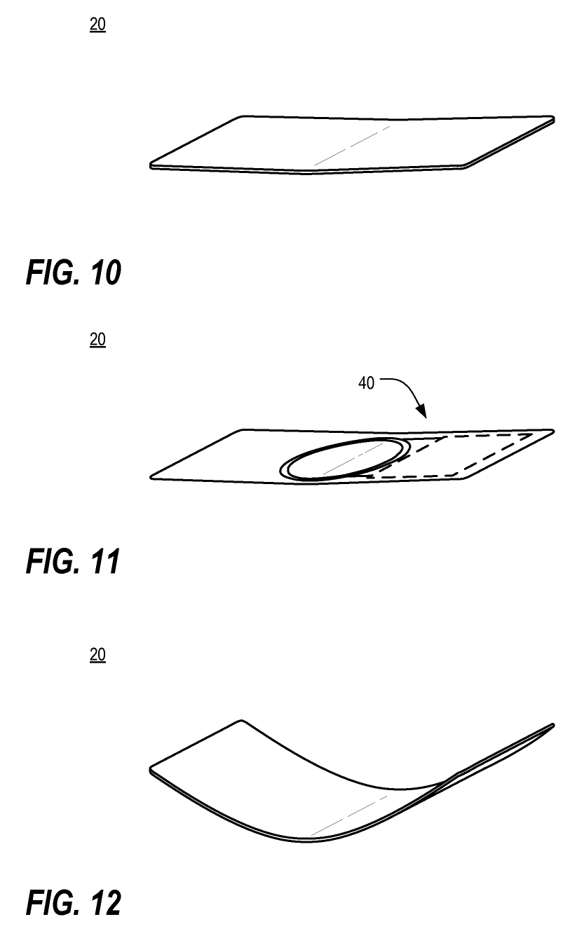

As described previously, the piezoelectric element itself is actuated by bending or deflecting the material making up the element such that the necessary pulse of energy is produced. This, in turn, is accomplished by bending, flexing, squeezing or otherwise deflecting the RFID card 20 such that the element contained therein is properly bent or deflected. FIGS. 10 and 11 are perspective views of the RFID card 20 of FIG. 1 and the middle layer 24 of the RFID card 20 of FIG. 4, respectively, shown in an activated state; and FIG. 12 is a perspective view of the RFID card 20 of FIG. 1 shown in an alternative activated state. Although the required amount of bending or deflection, which as used herein includes any type of mechanical adjustment to the basic shape of the card 20, may vary depending on the magnitude of the electric potential required for operation of the circuit 40, the amount of required bending or deflection should be limited to that which may be easily produced by most users and should also not be so great as to cause damage to the card 20 or the circuit 40 therein, even when repeated many times over the life of the card 20. The relatively minor amount of deflection illustrated in FIGS. 10 and 11 may be appropriate to accomplish these purposes, or the greater amount of deflection illustrated in FIG. 12 may be more appropriate.

It will be appreciated that various aspects of the card 20, and especially of the circuit 40, may be designed to produce desired timing effects, including the length of time that the antenna may be activated by the piezoelectric element, the length of time after the piezoelectric element has activated the antenna before it can be used to activate the antenna again, and the like.

Notably, the resulting RFID technology in the various implementations 200,300,400 described herein is passive in nature in that the power necessary to read the RFID data information and transmit it to the RFID reader terminal 12 is provided by the RIFD reader terminal via the respective antenna 212,312,403, and not by the respective piezoelectric element 210,310,402, a battery, or some other source. In each circuit 40, the antenna remains fully connected to the RFID element 208,308,408, but the connection of the piezoelectric element within the circuit prevents the antenna from interacting with the RFID reader terminal to receive the necessary power unless the piezoelectric element is actuated at the same time. In the implementations 200,300 of FIGS. 7 and 8, this is accomplished by short-circuiting the antenna 212,312 unless the piezoelectric element 210,310 is actuated, while in the implementation 400 of FIG. 9, this is accomplished by forcing the antenna 403 out of resonance unless the piezoelectric element 402 is actuated.

In at least one embodiment of a system of the present invention, the system 10 further includes, in addition to one or more cards 20 of the present invention, one or more conventional cards, wherein the conventional cards do not include a piezoelectric element and are adapted to respond to the RFID reader terminal conventionally. In other words, the cards 20 of the present invention may be interchangeable with conventional cards in a particular system. In at least some respects, the cards 20 of the present invention may be considered more secure than conventional cards, but it is not necessary for all RFID cards authorized for use in a given system, or with a particular RFID terminal 12, to utilize piezoelectric elements therein.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

1. A radio-frequency identification (RFID) card, comprising:
at least one card layer; and
an electrical circuit, carried by the at least one card layer, including:
an RFID element that is adapted to store RFID data information,
an antenna, electrically connected at each of two ends to the RFID element, and
a piezoelectric element, electrically connected to at least one of the two ends of the antenna,
whereby mechanical actuation of the piezoelectric element enables the antenna to be energized by a transmission from an RFID reader terminal, thereby powering the transmission of RFID data information from the RFID element to the RFID reader terminal.

2. The RFID card of claim 1, wherein mechanical actuation of the piezoelectric element occurs when the at least one card layer is flexed.

3. The RFID card of claim 1, wherein mechanical actuation of the piezoelectric element causes the removal of a short-circuit from the antenna.

4. The RFID card of claim 3, wherein the short-circuit is removed from leads of the antenna.

5. The RFID card of claim 3, wherein the short-circuit is removed from antenna inputs on the RFID element.

6. The RFID card of claim 1, wherein the RFID element is implemented in an integrated circuit.

7. The RFID card of claim 1, wherein the RFID element does not include an integrated circuit.

8. The RFID card of claim 1, further including an additional circuit portion, electrically connected to the antenna and to the piezoelectric element, that enables the antenna to be energized by the transmission from the RFID reader terminal.

9. The RFID card of claim 8, wherein the additional circuit portion includes a transistor that removes a short-circuit from the antenna when an electric potential, generated by the actuation of the piezoelectric element, is applied thereto.

10. The RFID card of claim 9, wherein the additional circuit portion further includes a diode, electrically connected between the piezoelectric element and the transistor, that rectifies the electric potential generated by the piezoelectric element.

11. The RFID card of claim 9, wherein the transistor is a junction gate field-effect transistor (JFET).

12. The RFID card of claim 9, wherein the transistor is a metal-oxide-semiconductor field-effect transistor (MOSFET).

13. The RFID card of claim 9, wherein a source lead of the transistor is electrically connected to a first end of the antenna and a drain lead of the transistor is electrically connected to a second end of the antenna.

14. The RFID card of claim 13, wherein the electric potential generated by the actuation of the piezoelectric element is applied to a gate lead of the transistor.

15. The RFID card of claim 9, wherein the additional circuit portion further includes a resistor, electrically connected to the transistor, to bleed stored capacitance from the transistor.

16. The RFID card of claim 8, wherein the additional circuit portion includes a capacitor network that tunes the circuit to the carrier frequency of the antenna when an electric potential, generated by the actuation of the piezoelectric element, is applied thereto.

17. The RFID card of claim 16, wherein the capacitor network includes a first capacitor and a second capacitor.

18. The RFID card of claim 17, wherein the RFID element includes two antenna inputs, and wherein the first capacitor is electrically connected across the two antenna inputs.

19. The RFID card of claim 18, wherein a first lead of the antenna is electrically connected to a first of the two antenna inputs, a second lead of the antenna is electrically connected to a first end of the second capacitor, and wherein a second end of the second capacitor is electrically connected to the first capacitor and to the second of the two antenna inputs.

20. The RFID card of claim 16, wherein the capacitor network is connected across the leads of the antenna.

21. The RFID card of claim 8, wherein the additional circuit portion is implemented together with the RFID element in a single integrated circuit.

22. The RFID card of claim 8, wherein the RFID element is implemented in an integrated circuit, and wherein the additional circuit portion is implemented separately from the integrated circuit of the RFID element.

23. The RFID card of claim 22, wherein the additional circuit portion is implemented in an integrated circuit that is separate from the integrated circuit of the RFID element.

24-152. (canceled)
